(19) United States
(12) Patent Application Publication
(10) Pub. No.: US 2013/0121835 A1
(43) Pub. Date: May 16, 2013

(54) WIND-POWERED MODULAR SAVONIUS ROTOR ELECTRICAL GENERATION AND FLUID PUMPING DEVICE

(71) Applicants: Steven Christopher Polaski, Chiang Mai (TH); Kenneth Owens Morgan, Henderson, NV (US); John Christian Hubble, San Diego, CA (US); Thomas Joseph Deschenes, Chiang Mai (TH)

(72) Inventors: Steven Christopher Polaski, Chiang Mai (TH); Kenneth Owens Morgan, Henderson, NV (US); John Christian Hubble, San Diego, CA (US); Thomas Joseph Deschenes, Chiang Mai (TH)

(21) Appl. No.: 13/462,802

(22) Filed: May 2, 2012

Related U.S. Application Data
(60) Provisional application No. 61/481,618, filed on May 2, 2011.

(51) Int. Cl. F03D 3/06

(52) U.S. Cl. CPC F03D 3/064
USPC 416/204 R

(57) ABSTRACT

Provided are systems and methods for a wind-powered electrical generation and fluid pumping device, including: a drive shaft; a generator comprising a rotor, wherein the generator may be coupled to the drive shaft by means of the rotor; and at least one vane pair, the vane pair comprising ribs and a structural twist, wherein the at least one vane pair is attached to the drive shaft by screws and square washers and further wherein vane extensions may be attached to the at least one vane pair with rivets. The vertical wind-powered electrical generation device is also described. It utilizes unique improvements of shaft coupling (to generator and rotor), the strengthening of complete Savonius rotor system, and ease of assembly. The vane pairs may be a segmented Savonius rotor. They may also create a helix pattern as they are installed.

### CROSS-REFERENCE TO RELATED APPLICATIONS

This application incorporates by reference and claims priority to U.S. Provisional Patent Application No. 61/481,618 filed May 2, 2011.

### BACKGROUND OF THE INVENTION

The present disclosure generally relates to the field of electric power generators and fluid pumping devices. In particular, to electric power generators and fluid pumping devices driven by wind energy through different types of rotors, for example, a Savonius rotor.

### SUMMARY OF THE INVENTION

Systems and methods for wind powered electrical generation and fluid pumping devices are provided, specifically, of electric power generations that may be driven by wind energy using different types of rotors also known as turbines, for example, a unique, segmented Savonius rotor which may be easily handled, transported, assembled and/or maintained. A Savonius wind turbine is a vertical-axis wind turbine used for converting the force of wind into torque on a rotating rotor.

Additional objects, advantages and novel features of the present subject matter will be set forth in the following description and will be apparent to those having ordinary skill in the art in light of the disclosure provided herein. The objects and advantages of the invention may be realized through the disclosed embodiments, including those particularly identified in the appended claims.

### BRIEF DESCRIPTION OF THE DRAWINGS

The drawings depict one or more implementations of the present subject matter by way of example, not by way of limitation. In the figures, the reference numbers refer to the same or similar elements across the various drawings.

FIG. 1 illustrates an isometric view of a wind-powered rotor electrical generation device according to an embodiment of the present disclosure.

FIG. 2 illustrates an exploded view of a vane pair assembly according to an embodiment of the present disclosure.

FIG. 3 illustrates a top view of a vane pair assembly according to an embodiment of the present disclosure.

FIG. 4 illustrates an isometric view of a vane pair assembly installed on a drive shaft according to an embodiment of the present disclosure.

FIG. 5 illustrates a front view of a wind-powered rotor electrical generation device, with a cut view to view the internal structure, according to an embodiment of the present disclosure.

FIG. 6 illustrates an isometric view of a multiple vane pair assembly installed on a drive shaft, according to an embodiment of the present disclosure.

### DETAILED DESCRIPTION OF THE INVENTION

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment, and such references mean at least one.

The use of headings herein is merely provided for ease of reference and shall not be interpreted in any way to limit this disclosure or the following claims.

Reference in this specification to “one embodiment” or “an embodiment” or the like means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Wind-powered or wind-driven electricity generation and fluid pumping devices are a significant source of renewable electrical energy and fluid pumping. Some electric power generators may be aligned horizontally, or mounted on tall masts and may resemble large propeller-equipped aircraft engines, whereas other electric power generators and fluid pumpers may be vertically aligned and equipped with two or more elongated vertical vane-like rotors.

In its most basic configuration, a Savonius rotor may have a S-shaped cross-section and may also consist of a vane pair comprising two inter-connected vertical vanes with a small overlap between them. The vane pair may be an individual component and may also be mounted on a central vertical shaft, for example. In one implementation, Savonius rotors may have more than two interconnected vanes. See, e.g., Grinspan et al., PROC. Of 28th NAT'L CONF. ON FLUID MECHANICS AND FLUID POWER, pp. 428-431 (Chandigarh, India; 2011). The number of vanes can be variable and the present disclosure is not limited to a set value or amount of vanes. Furthermore, the term “vane pair” as used herein shall be considered to encompass all such multiples or numbers of vanes, not just two vanes. In one implementation, a “vane pair” may comprise a two-vane structure.

In one implementation, the design of the present disclosure may consist of vane pairs that may all be the same size. A given vane pair is installed on a vertical shaft using a vane bracket, and the vane bracket may then be clamped, bolted, interlocked or swaged onto the shaft. The vanes may be installed in a helical twist where each vane pair has an angled offset from the previous pair, for instance. In one implementation, the shaft may be coupled to an electric generator, fluid pumping device or compressor that provides electric power or fluid pumping compression.

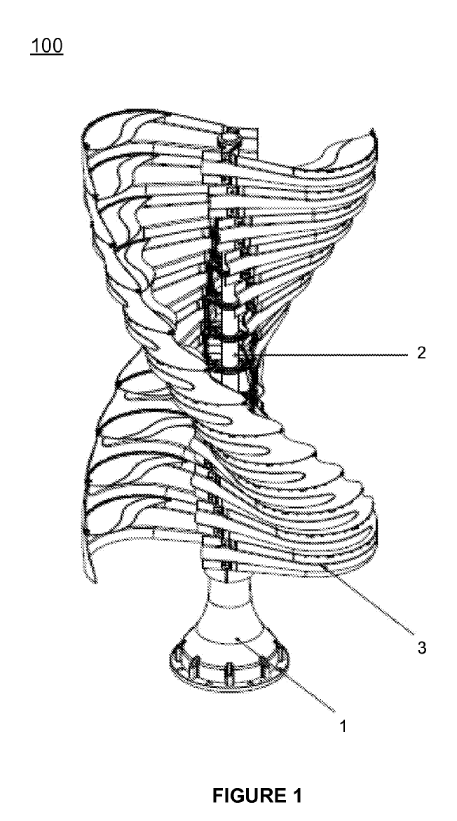

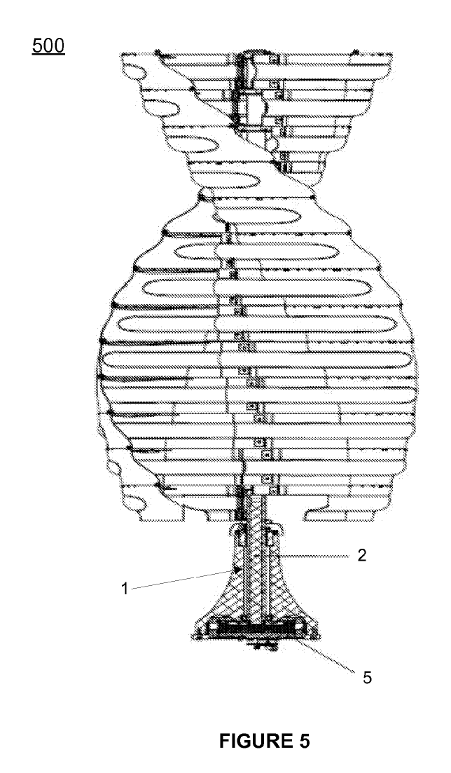

FIG. 1 illustrates an isometric view of a wind-powered rotor electrical generation device according to an embodiment of the present disclosure. As shown in FIG. 1, device 100 comprises components including generator 1, drive shaft 2 and vane pair assembly 3. In one implementation, the drive shaft 2 may be directly attached to the rotor 5 (shown in FIG. 5) of generator 1. The generator 1 may be an electric generator known in the art that provides electric power to the entire device 100. Generator 1 may also be made of materials including, for example, metal, plastic, carbon, permanent magnets, steel, stainless steel, and aluminum. Drive shaft 2 may be made of materials including, for example, metal, plastic, carbon, aluminum, high strength steel and carbon fiber. Vane pair assembly 3 may also be made of materials including, for example, metal, plastic, carbon, aluminum and carbon fiber. In one implementation the device 100 may be vertically oriented as shown in FIG. 1, in a helix or helix-like visual structure. In one implementation, the device 100 may be horizontally oriented. The modular configuration of the present application and how the entire system fits together allows the present application to be shipped in a compact crate. It also provides the present application with the advantage of interchangeability for replacement parts or upgrades. The robust construction and the use of resolute materials in the present application create an extremely strong turbine that can survive extremely high wind regimes unlike horizontal turbines and the turbines of other competitors. For example, the ribs on the Vanes create a sturdy Vane structure that can withstand high wind forces. The actual geometry of this ribbing also provides multiple efficiency characteristics, one including air capture on the intake and less friction resistance with the drag effect.

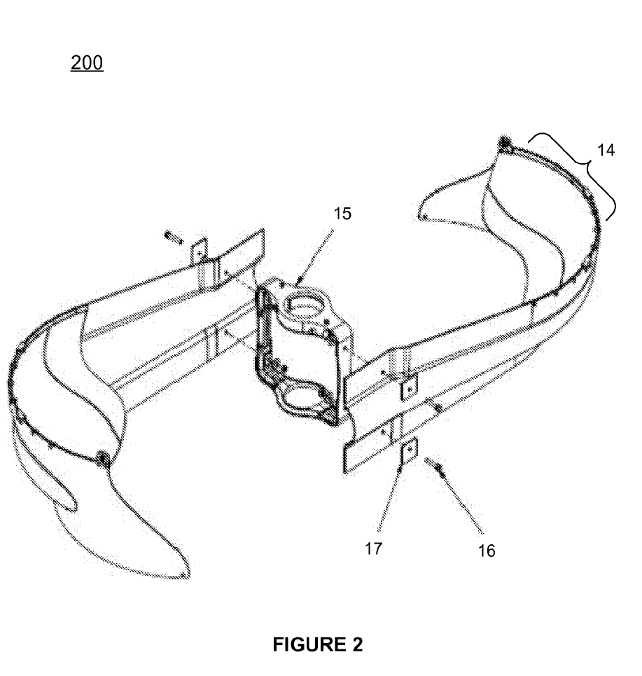

FIG. 2 illustrates an exploded view of a vane pair assembly according to an embodiment of the present disclosure. Device 200 shows vanes 14, vane bracket 15, screws 16, and square washers 17. Vanes 14 may be attached to the vane bracket 15 by screws 16 in the attachment configuration as shown in FIG. 2. Square washers 17 may also be used to spread out the stresses in the attachment configuration of the vanes by the screws, as shown in FIG. 2. In one implementation, the screws 16 may be threaded through holes in the vanes 14 and further secured by the square washers 17, as shown by the configuration of FIG. 2. In one implementation, vane pairs may be attached to other vane pairs by screws 16 that may be located on the outside surface or tip of the vane. This configuration serves to provide a structural component to reinforce the overall structure of the device, and not having such reinforcement may weaken the device and cause it to be subject to damage.

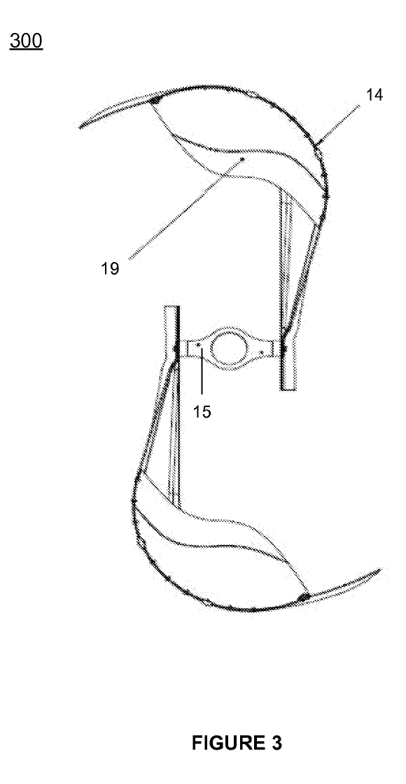

FIG. 3 illustrates a top view of a vane pair assembly according to an embodiment of the present disclosure. Device 300 shows, from a top view, vane bracket 15, vanes 14 as well as vane extensions 19. In one implementation, vanes 14 may be in a twisted form that corresponds to a degree that the helix-like structure is created in device 300 by stacking the vane pairs on top of one another. Vane extensions 19 may be installed on a vane by rivets, for example, allowing the vanes to capture more wind and strengthening the vane against high levels of wind resistance or providing overall reinforcement. Vane brackets 15 are more clearly seen from a bird's eye-view or top view.

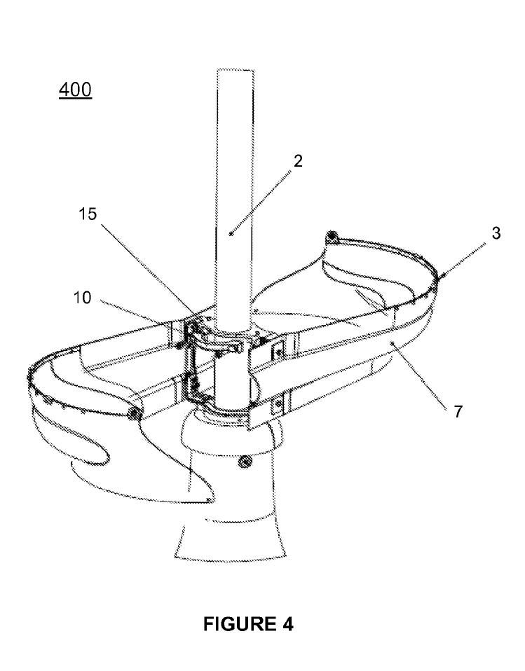

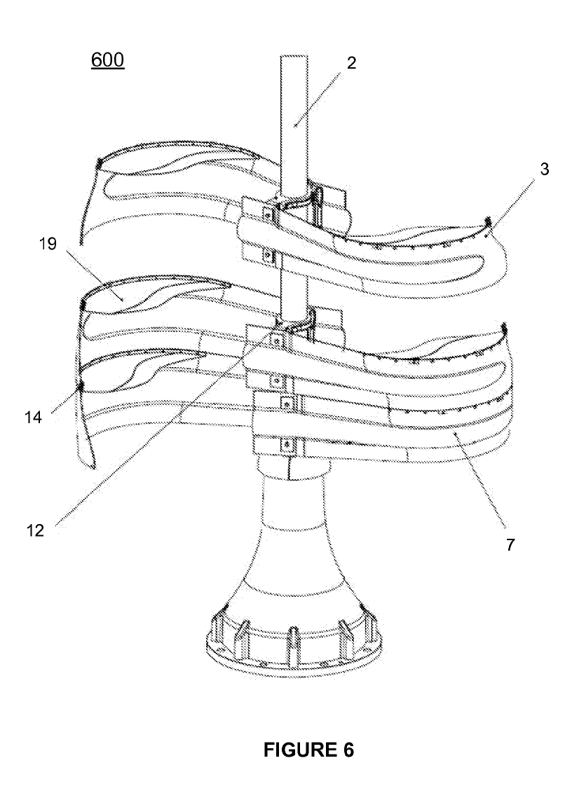

FIG. 4 illustrates an isometric view of a vane pair assembly installed on a drive shaft according to an embodiment of the present disclosure. Device 400 includes a vane pair 3, vane ribs 7, shaft 2, vane bracket 15, and vane clamp 10. Vane pair 3 may be installed onto the shaft 2 and clamped into place via vane clamp 10 by the vane bracket 15, directly to the shaft 2. The next vane pair (not shown) may then be installed on the shaft 2. In one implementation, pins may align the next vain pair on an offset angle of, for example, 15 degrees (shown in offset orientation 12 in FIG. 6). This may continue until the shaft 2 is completely filled with vane pairs 3. In one implementation, the vanes of vane pairs 3 may have vane ribs 7 or a ribbed feature that may start at the boot or base of a vane and extends substantially to the top of the vane. In one implementation, the specific twist of a vane is a unique structural feature of the vane. In one implementation, the ribbed feature and the specific twist of a vane may be combined, mixed or matched in order to come up with a structurally unique vane design.

FIG. 5 illustrates a front view of a wind-powered rotor electrical generation device, with a cut view to view the internal structure, according to an embodiment of the present disclosure. Device 500 shows a generator 1, drive shaft 2 and rotor 5, the rotor 5 belonging to the generator 1. In one implementation, the drive shaft 2 may be directly attached to the rotor 5 of the generator 1. In one implementation, the drive shaft 2 may not be directly attached to the rotor 5 of the generator 1 and may instead be attached or coupled or electrically linked by other connective means.

FIG. 6 illustrates an isometric view of a multiple vane pair assembly installed on a drive shaft, according to an embodiment of the present disclosure. Device 600 includes vane pairs 3, offset orientation 12, shaft 2, vanes 14, vane ribs 7 and vane extensions 19. The vane pairs 3 may be installed onto the shaft 2 (for instance, by the vane clamps 10 and vane brackets 15 as shown by and discussed in FIG. 4). In one implementation, each vane pair 3 may be installed onto the shaft 2 one-by-one. In one implementation, multiple vane pairs 3 may be installed onto the shaft 2. In one implementation, pins (not shown) align the subsequently installed vane pairs at an offset orientation 12. In one implementation, the offset orientation 12 can be, for example, 15 degrees. The process of installing vane pairs 3 continues until the shaft is complete with vane pairs, which can mean either there is no more space to install additional vane pairs 3 or the amount of vane pairs 3 currently on the shaft is deemed satisfactory by whoever plans to use the device. Vanes 14 may also have vane ribs 7 that start at the boot or base of the vane 14 and extend almost to the tip of the vane 14. The vanes 14 may also have a specific twist that may add to its unique structural features, which may be combined or mixed and matched with the vane ribs 7 of the vanes 14. Vane extensions 19 may also be installed on a vane 14 by rivets, which may allow a vane 14 to capture more wind and which structurally strengthens or reinforces the vane 14. As the wind blows, the drive shaft rotates from the force of the wind exerted on the vanes. This rotational momentum is translated to the rotor of the generator. The rotor consists of individual permanent magnets that, when they passed by a wired coil, create a current of electricity. The Generator is made of materials such as, for example, metal, plastic, carbon, permanent magnets, steel, stainless steel and aluminum. The drive shaft can be made of materials such as, for example, metal, plastic, carbon, aluminum, high strength steel and carbon fiber. The vane can be made of materials such as, for example, metal, plastic, carbon, aluminum and carbon fiber.

In one implementation, the method of creating the vanes or the vane pairs may be performed by a large forming tool. In one implementation, the method for creating the generator housing and vane bracket may also be a casting tool. In one implementation, the rest of the components and parts are machined. In one implementation, the method of creating the vanes using a metal forming process may be distinct to the above present disclosure. In one implementation, the method for creating the generator housing and the vane brackets may use a casting method. The metal forming process used to create the vanes may be described as follows (with steps not limited to the order of steps described): a blank flat pattern of the vane is created by a stamping or tool cutting process. After stamping, the vane blank is inserted into the tooling that is attached to the large forming machine. The tooling may be a machined assembly that consists of a part A and a part B. The contoured shape of the tooling corresponds to the final shape of the vane plus the required rebound that is intrinsic in the metal after being brought to its yield strength. The large forming machine is then actuated and the vane blank may then be formed into its final shape. In one implementation, the forming tool may be a distinct device, mechanism or device unique to the present application used to create the vanes. In one implementation, the casting tool may be a casting tool known in the prior art.

In one implementation, vane extensions may also be known as air dams or dams. In one implementation, vane brackets may also be known as Vane-brackets or Vane-brackets.

In one implementation, possible applications of the present disclosure include applying the above-described device to water pumping, cell tower power or powering larger energy resources or factories. Solar panels may be combined with the vane design to maximize accumulation of energy to power, for example, billboards or electrical grids. Devices having the solar panels and other features may also be arranged in a larger vertical wind-turbine farm conducive to gathering the most wind energy in order to accumulate the maximum amounts of energy.

Provided is a wind-powered electrical generation device, comprising: a drive shaft; a generator comprising a rotor, and at least one vane pair. The generator may be coupled to the drive shaft by being attached to the rotor. The vane pair, the vane pair is comprised of complex geometric ribs and a structural twist, derived from a computational fluid dynamic algorithm one or more vane pairs is attached to the drive shaft by a clamp via vane bracket screws. The vanes are attached to the vane bracket by bolts and washers and wherein vane extensions may be attached to the one or more vane pair with rivets, and the washers are used to distribute the high pressure loading exhibited in the vanes during operation. This design is derived from an in-depth finite element analysis of the dynamic and static loading of the vane pairs and vane bracket. The specific shape of the vane in addition to the system of fully assembled vane pairs is derived from a computational fluid dynamic algorithm, which specifically inhibits harmonic resonances, erratic vibrations, and structural instabilities due to static and dynamic responses, wherein the vane extensions provide structural rigidity to the vane along with increasing the efficiency of the system, and wherein the vane brackets were designed with consideration to their structural strength and aerodynamic effect, and further wherein the vane brackets are derived from a computational fluid dynamic study and finite element analysis.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

We claim:

1. A wind-powered electrical generation device comprising:
a generator comprising a rotor;
a drive shaft coupled to the rotor; and
at least one vane pair assembly coupled to the drive shaft, each vane pair assembly includes two vanes and a vane bracket, wherein the vanes are coupled to the vane bracket and the vane bracket is coupled to the drive shaft.

2. The wind-powered electrical generation device of claim 1 wherein the vane pair assembly includes a vane extension attached to each of the vanes.

3. The wind-powered electrical generation device of claim 2 wherein the vane extensions are riveted to the vanes.

4. The wind-powered electrical generation device of claim 1 wherein the two vanes in each vane pair assembly are coupled to opposing sides of the vane bracket.

5. The wind-powered electrical generation device of claim 1 wherein each vane includes a rib.

6. The wind-powered electrical generation device of claim 1 wherein each vane pair includes a vane clamp securing the bracket to the drive shaft.

7. The wind-powered electrical generation device of claim 1 further including a plurality of vane pairs coupled to drive shaft, each adjacent vane pair coupled to the drive shaft in an offset orientation around an axis of the drive shaft.

8. The wind-powered electrical generation device of claim 7 wherein the plurality of vane pairs are coupled to the drive shaft in an offset orientation around the axis of the drive shaft to form a helical shape.

9. The wind-powered electrical generation device of claim 8 wherein the offset orientation between adjacent vane pairs is 15 degrees.

10. The wind-powered electrical generation device of claim 1 wherein the vanes are coupled to the vane bracket with screws.
